(19) United States
(12) Patent Application Publication
(10) Pub. No.: US 2013/0175122 A1
(43) Pub. Date: Jul. 11, 2013

(54) HUB BRAKE FOR A BICYCLE

(71) Applicant: Tseng-Ping TIEN, Taichung City (TW)

(72) Inventor: Tseng-Ping TIEN, Taichung City (TW)

(73) Assignee: FOSS WORLDWIDE INC., Taichung City (TW)

(21) Appl. No.: 13/475,071

(22) Filed: May 18, 2012

(30) Foreign Application Priority Data
Jan. 6, 2012 (TW) 101100549

(51) Int. Cl. B62L 1/00; B62L 3/02

(52) U.S. Cl. 188/72.4; 188/72.1

(57) ABSTRACT

A hub brake for a bicycle mainly comprises a fixed brake disc, axial displacement brake disc and brake member. The axial displacement brake disc is driven by the brake member to yield axial displacement, thus realizing axial hub braking through frictional abutting of the fixed brake disc. As the fixed brake and axial displacement brake disc are both of simplified disc or block structure, the manufacturing process can be streamlined for mass production, while convenient and efficient assembly from one end of the hub is made possible. As for the ringed brake interface formed between the fixed brake disc and axial displacement brake disc, its friction area is not less than that of conventional drum or caliper brake interface. Hence, the hub brake components of the bicycle could be greatly simplified, and the weight and assembly space could be reduced for easier production, convenient assembly and satisfactory braking performance.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a local structure of a bicycle, and more particularly to an innovative one which is designed with hub brake.

2. Description of Related Art Including Information Disclosed Under 37 CFR 1.97 and 37 CFR 1.98

Currently, there are a variety of brake devices for bicycles, which are divided into rim brake and hub brake according to the assembly position. Of which, the rim brake is divided into cantilever and pull types. As the rim is the braking object in the rim brake, a bigger problem occurs, namely, with the development trend of lightweight bicycle products, the rim of bicycle is made of light aluminum alloy or carbon fiber, which, however, has poorer resistance to high temperature. When the bicycles are intensely used, the frequent and forcible braking will generate instant high temperature at the braking interface (note: approx. 200° C.), leading easily to the deformation or even damage and much shorter service life of the rims.

As for the hub brake design, its braking interface is located at the hub, so this is not related to the rim but more suitable for existing lightweight bicycle structure. Yet, the conventional hub brake has shortcomings such as: complex components, high manufacturing cost and inconvenient assembly, which are attributable to the conventional design that the structure of drum brake is transferred to the bicycle's hub space. However, it is well understood that the bicycle's hub (especially the front wheel hub) is of a narrow and limited tubular space, so technical problems and bottlenecks will be encountered if it is intended for setting traditional drum brake into it. The braking force and effect will be compromised if it is miniaturized to match the bicycle's hub space. So, it is found from the prior arts that, the hub space is generally multiplied with the setting of braking components, yielding negative impact on the lightweight development and manufacturing cost of the overall structure of bicycle.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the unique design wherein the present invention mainly comprises said fixed brake disc, axial displacement brake disc and brake member, the axial displacement brake disc is driven by the brake member to yield axial displacement, thus realizing axial hub braking through frictional abutting of the fixed brake disc. As the fixed brake disc and axial displacement brake disc are both of simplified disc or block structure based on the structural design of simplified hub brake, the manufacturing process can be streamlined for mass production, while convenient and efficient assembly from one end of the hub is made possible. Moreover, as for the ringed brake interface formed between the fixed brake disc and axial displacement brake disc, its friction area is not less than that of conventional drum or caliper brake interface. Hence, the hub brake components of the bicycle could be greatly simplified, and the weight and assembly space could be reduced for easier mass production, more convenient assembly and more satisfactory braking performance.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an assembled sectional view of the bicycle's hub brake of the present invention.

FIG. 2 is a sectional view of the preferred embodiment of the bicycle's hub brake components of the present invention.

FIG. 3 is a schematic view of the present invention showing that the brake member's driving end is pulled by pressing the brake handle of the bicycle.

FIG. 4 is an actuating sectional view of another preferred embodiment of the bicycle's hub brake of the present invention.

FIG. 5 is a partially enlarged view of the present invention wherein a concave portion is set on the second braking surface of the axial displacement brake disc.

FIG. 6 is a partially enlarged view of the present invention wherein an air vent is set on the hub brake of the bicycle.

FIG. 7 is a sectional view of an embodiment of the present invention wherein the hub brake is applied to the rear wheel of the bicycle.

FIG. 8 is a sectional view of the present invention wherein the fixed brake disc and the axial displacement brake disc are assembled externally onto the hub.

### DETAILED DESCRIPTION OF THE INVENTION

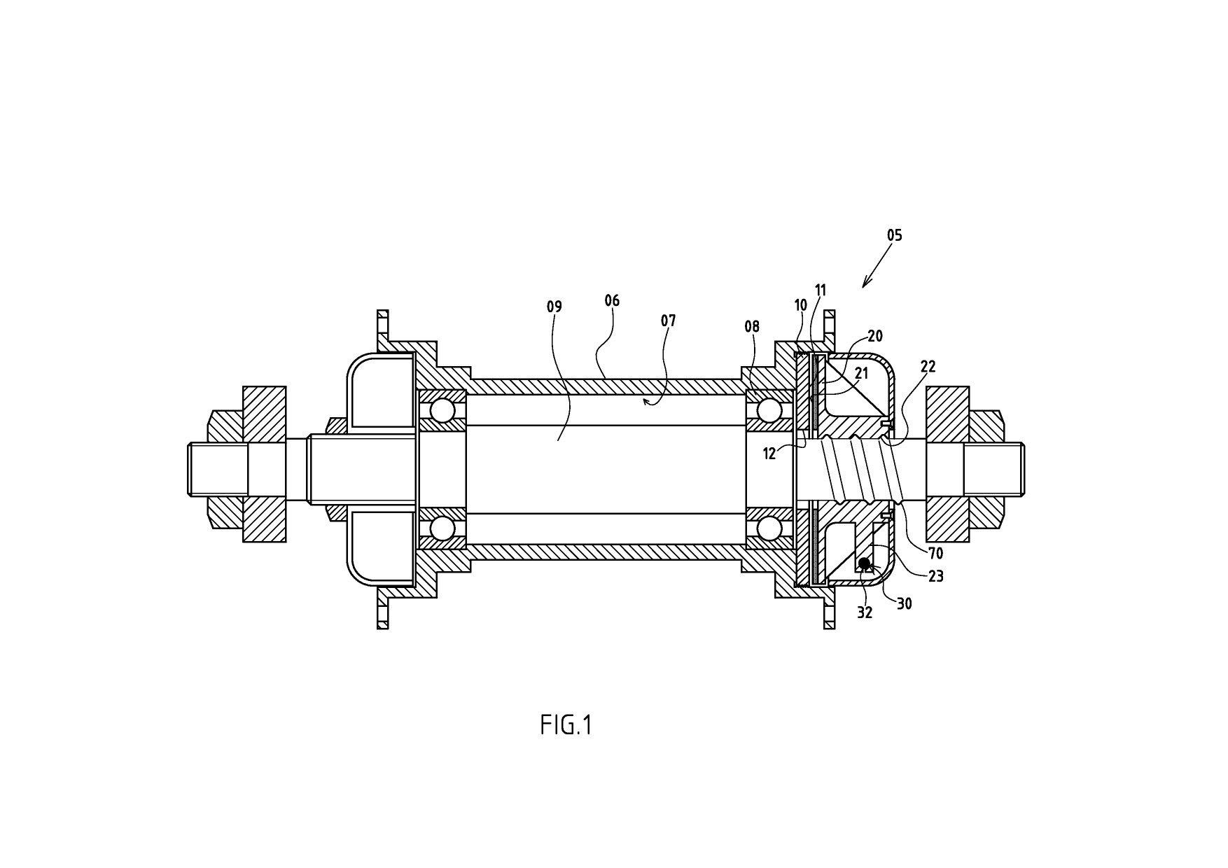

FIGS. 1˜3 depict the preferred embodiments of the hub brake of the present invention, which, however, are provided for only explanatory objective for patent claims. The hub brake 05 of said bicycle is set into the hub 06 of the bicycle's front or rear wheel for braking purpose. The hub 06 is provided with a hollow tubular space 07 and pivoted via the bearing 08 onto the periphery of the axle 09 of the bicycle's front or rear wheel

The hub brake 05 comprises a fixed brake disc 10, assembled securely at one end of the hub 06 and located onto the exterior of the bearing 08. In this preferred embodiment, the fixed brake disc 10 is assembled into the hollow tubular space 07 at one end of the hub 06. It comprises of a first braking surface 11 with its orientation the same as the axial direction of the axle 09. The center of the fixed brake disc 10 is provided with a penetrating portion 12 for the axle 09.

An axial displacement brake disc 20 is assembled at one end of the hub 06 and located onto the exterior of the fixed brake disc 10 correspondingly. The axial displacement brake disc 20 comprises of a second braking surface 21 set correspondingly to the first braking surface 11 of the fixed brake disc 10. Of which, the first and second braking surfaces 11, 21 are of any flat, curved and rugged planes; a guide sleeving portion 22 at the center of the axial displacement brake disc 20 is assembled at the periphery of the axle 09, and allowed for axial displacement along the axle 09. Moreover, the axial displacement brake disc 20 is provided with a driven portion 23, so as to control the braking or disengagement state between the first and second braking surfaces 11, 21.

Besides, the fixed brake disc 10 and axial displacement brake disc 20 are preferably made of highly thermostable, wear-proof metals such as babbitt metal. Either the first braking surface 11 or the second braking surface 21 is preferably made of highly thermostable, wear-proof combinations of ceramic and metals, so as to improve their wearing resistance, reduce the loss and increase the service life of the first and second braking surfaces 11, 21.

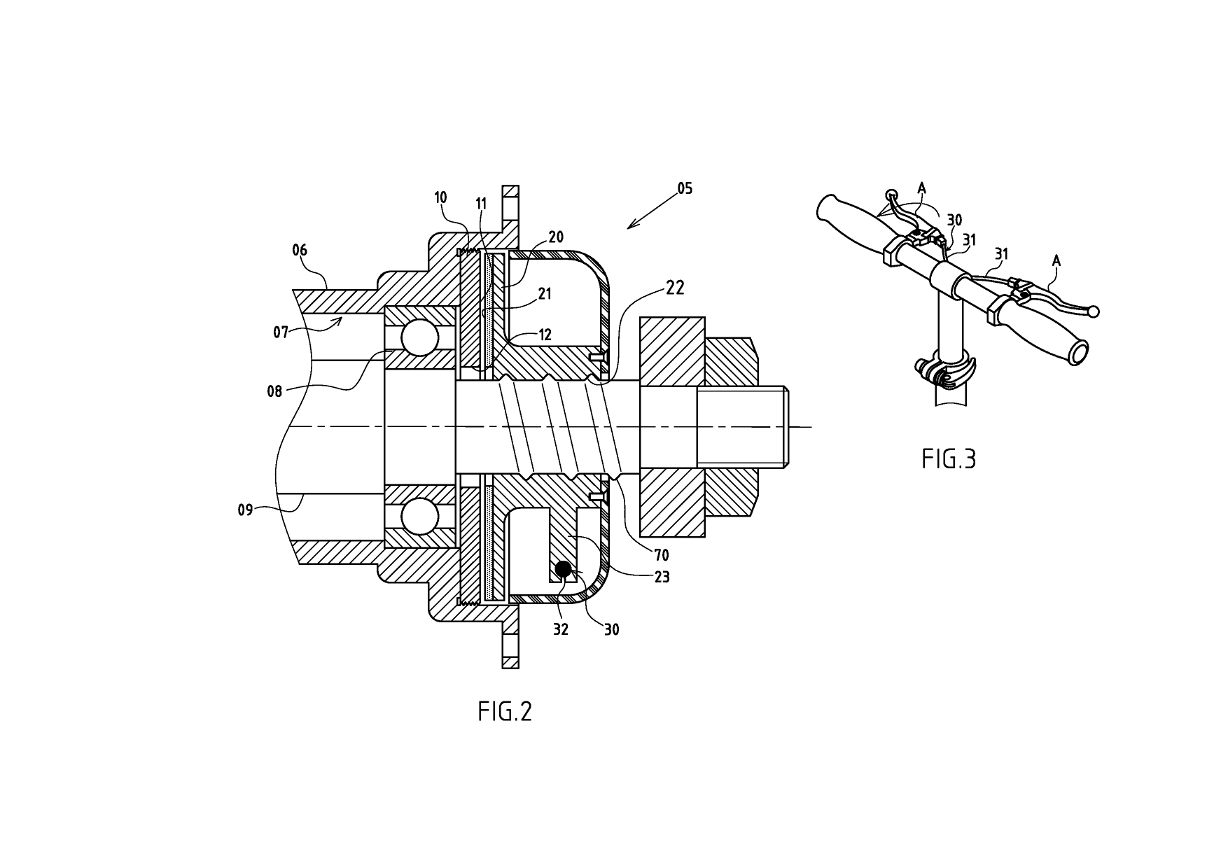

A brake member 30 comprises a driving end 31 and a driven end 32, of which the driven end 32 is connected with the driven portion 23 set on the axial displacement brake disc 20, and the driving end 31 connected with the brake handle A preset on the bicycle (shown in FIGS. 2, 3). With this design, the axial displacement brake disc 20 is driven by the brake member 30 to yield axial displacement, thus realizing hub braking through frictional abutting of the fixed brake disc 10. Moreover, the brake member 30 could also be designed into hydraulic braking type, helping to improve the braking capacity and running safety of the bicycle.

Referring to FIGS. 2 and 3, the guide sleeving portion 22 of said axial displacement brake disc 20 is designed with screwed holes, so that a male screwed section 70 is set on the periphery of the axle 09. With the mating of the screwed guide sleeving portion 22 and male screwed section 70, the axial displacement brake disc 20 enables axial displacement through rotation, so that the first and second braking surfaces 11, 21 could be engaged frictionally for braking. Moreover, the driven portion 23 set on the axial displacement brake disc 20 is designed with a protruding arm, the brake member is designed with a rope body, and the driven end 32 of the brake member 30 is connected at the end of the driven portion 23.

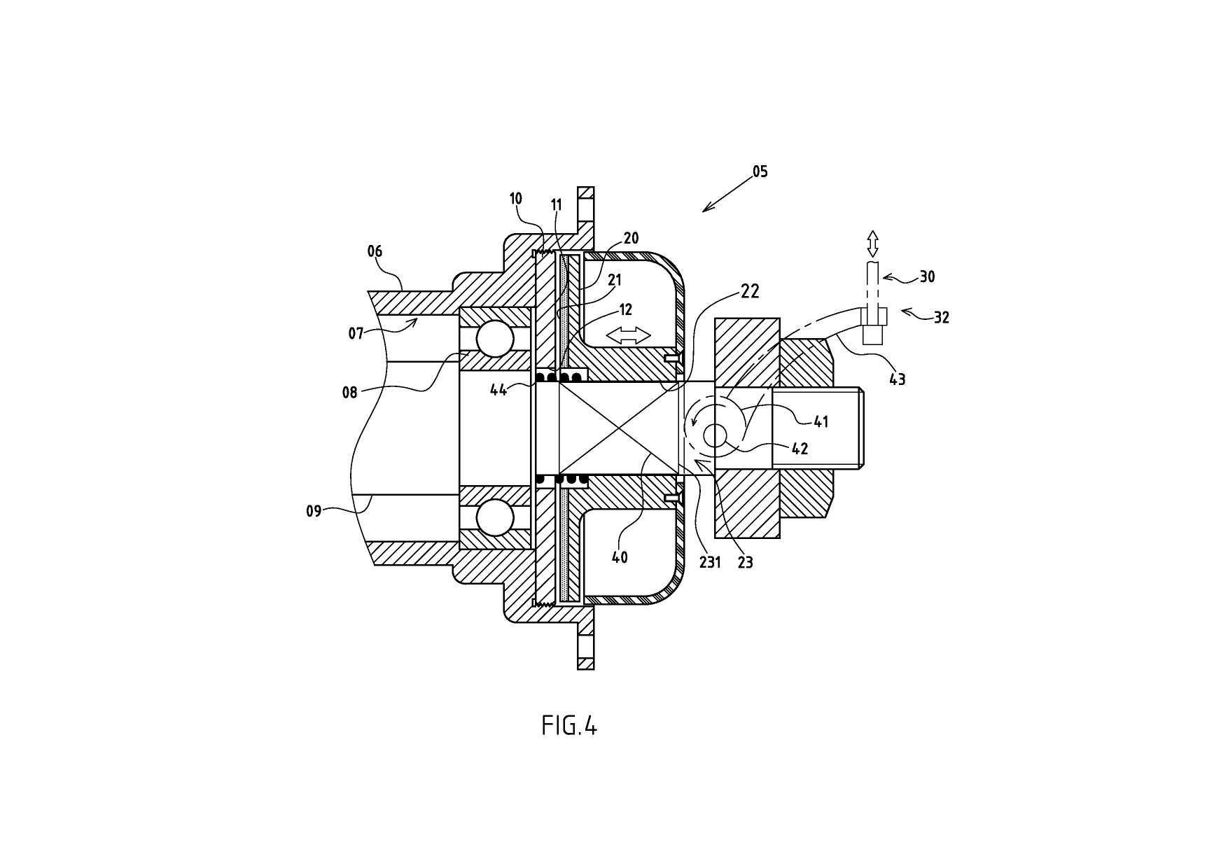

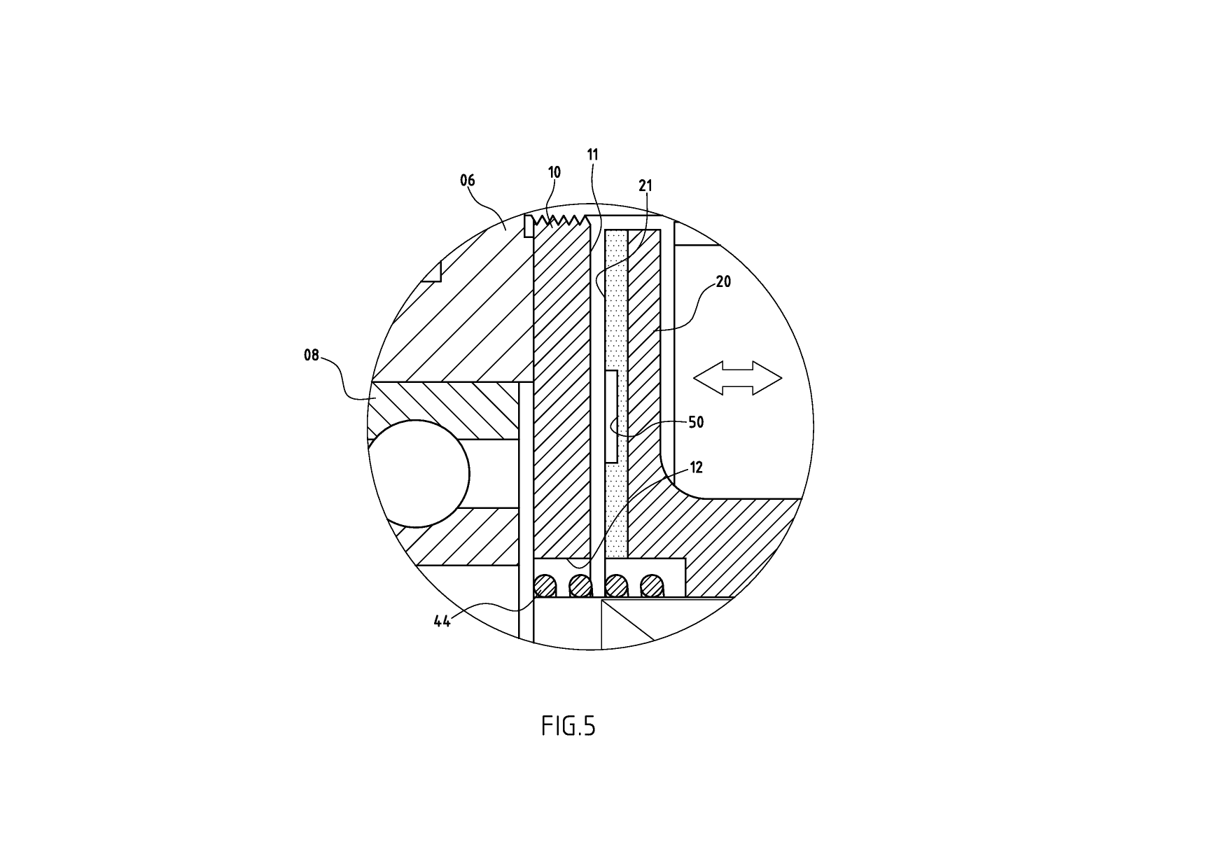

FIG. 4 depicts another preferred embodiment of the hub brake 05 of the present invention, wherein the guide sleeving portion 22 of said axial displacement brake disc 20 is designed with straight holes and sleeved on the periphery of the axle 09. A directional limiting portion 40 is set correspondingly to the guide sleeving portion 22 and the axle 09, so as to prevent the rotation of the axial displacement brake disc 20 in relation to the axle 09. Moreover, the driven portion 23 is formed by one end surface 231 of the axial displacement brake disc 20. The driven end 32 of the brake member 30 is also provided with a swinging arm 43 composed of eccentric cam 41 and fulcrum 42; the swinging arm 43 is located via the fulcrum 42 correspondingly to the outer end surface 231 of the axial displacement brake disc 20.

Based upon the above-specified structural design, the present invention is operated as follows:

Referring to FIGS. 2 and 3, when pressing the brake handle A in the movement, the driving end 31 of the brake member 30 will be driven to pull the driven end 32 connected with the driven portion 23 of axial displacement brake disc 20, allowing for rotation of the axial displacement brake disc 20, and realizing axial displacement of the guide sleeving portion 22 and the male screwed section 70 of the axle 09. Furthermore, the second braking surface 21 is shifted and abutted onto the first braking surface 11 to stop the bicycle through frictional abutting. When the brake handle A is released by the user, the pulling force of the driven end 32 of the brake member 30 will disappear, allowing for rotation of the axial displacement brake disc 20 to separate the second braking surface 21 from the first braking surface 11.

Referring to FIGS. 3 and 4, when pressing the brake handle A in the movement, the driving end 31 of the brake member 30 will be driven to pull the swinging arm 43 of the driven end 32. While the swinging arm 43 is actuated by the pulling of the brake member 30, the eccentric cam 41 is driven to rotate reversely and push the outer end surface 231 of axial displacement brake disc 20, so that the second braking surface 21 is shifted and abutted onto the first braking surface 11, thus realizing the braking state from the frictional abutting of the first and second braking surfaces 11, 21. When the brake handle A is released by the user, the axial displacement brake disc 20 is pushed elastically by an elastic member 44 set on the axle 09, so that the eccentric cam 41 is pushed by the outer end surface 231 of the axial displacement brake disc 20 to rotate positively for resetting it to the release state.

Referring to FIG. 5, a concave portion 50 is set locally onto either the second braking surface 21 or the first braking surface 11. In the preferred embodiment, the concave portion 50 is set onto the second braking surface 21 of the axial displacement brake disc 20 to remove chips and heat quickly, thus increasing the service life of the fixed brake disc 10 and the axial displacement brake disc 20.

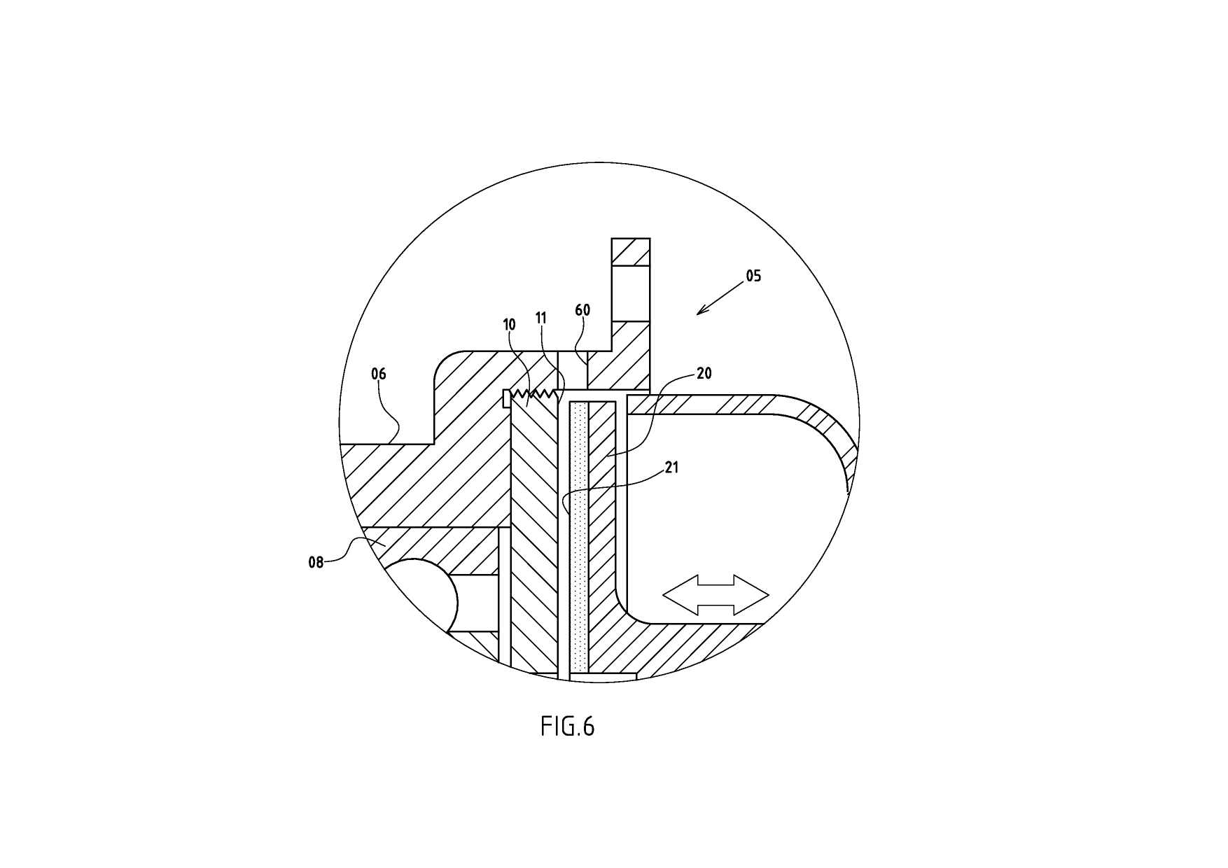

Referring to FIG. 6, an auxiliary heat emission structure such as air vent 60 or cooling fin (air vent 60 assembled herein) is set onto the hub 06 correspondingly to the assembly position of the fixed brake disc 10 and axial displacement brake disc 20, so as to improve the cooling efficiency.

Additionally, the assembly position of the fixed brake disc 10 and axial displacement brake disc 20 correspondingly to the hub 06 could be designed into external diameter expansion pattern, so as to increase the configuration area of the fixed brake disc 10 and axial displacement brake disc 20 for improved braking capability.

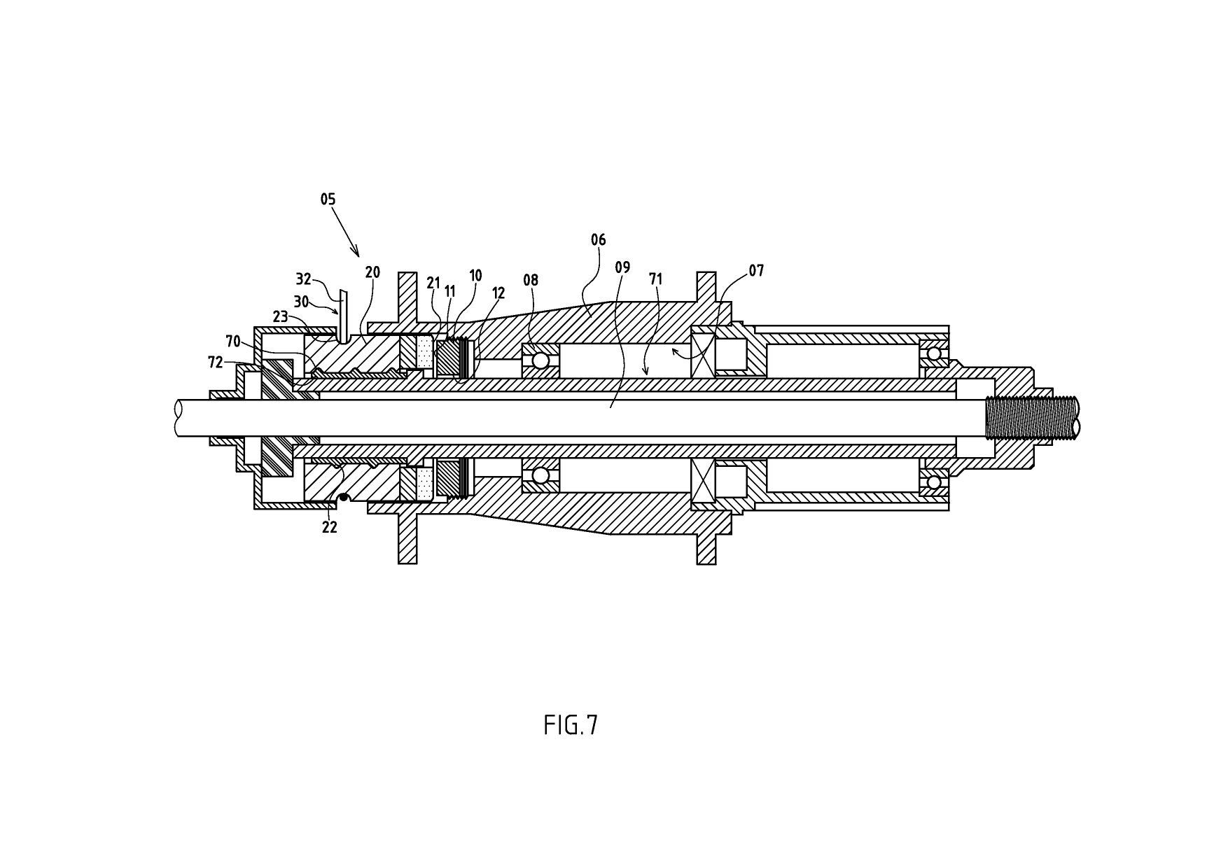

Referring to FIG. 7, the hub brake 05 is applied to the bicycle's rear wheel. The driven portion 23 of the axial displacement brake disc 20 could be designed with an inward flange, and the brake member 30 designed with a rope body, then the driven end 32 of the brake member 30 is set on the periphery of the flanged driven portion 23. When the brake member 30 is driven by the brake handle, the driven end 32 on the periphery of the driven portion 23 of the axial displacement brake disc 20 could be pulled, so that the axial displacement brake disc 20 could rotate to yield axial displacement along the braking sleeve 72 of the sleeve assembly 71 set externally onto the axle 09, so that the second braking surface 21 is shifted and abutted onto the first braking surface 11 for braking via frictional abutting.

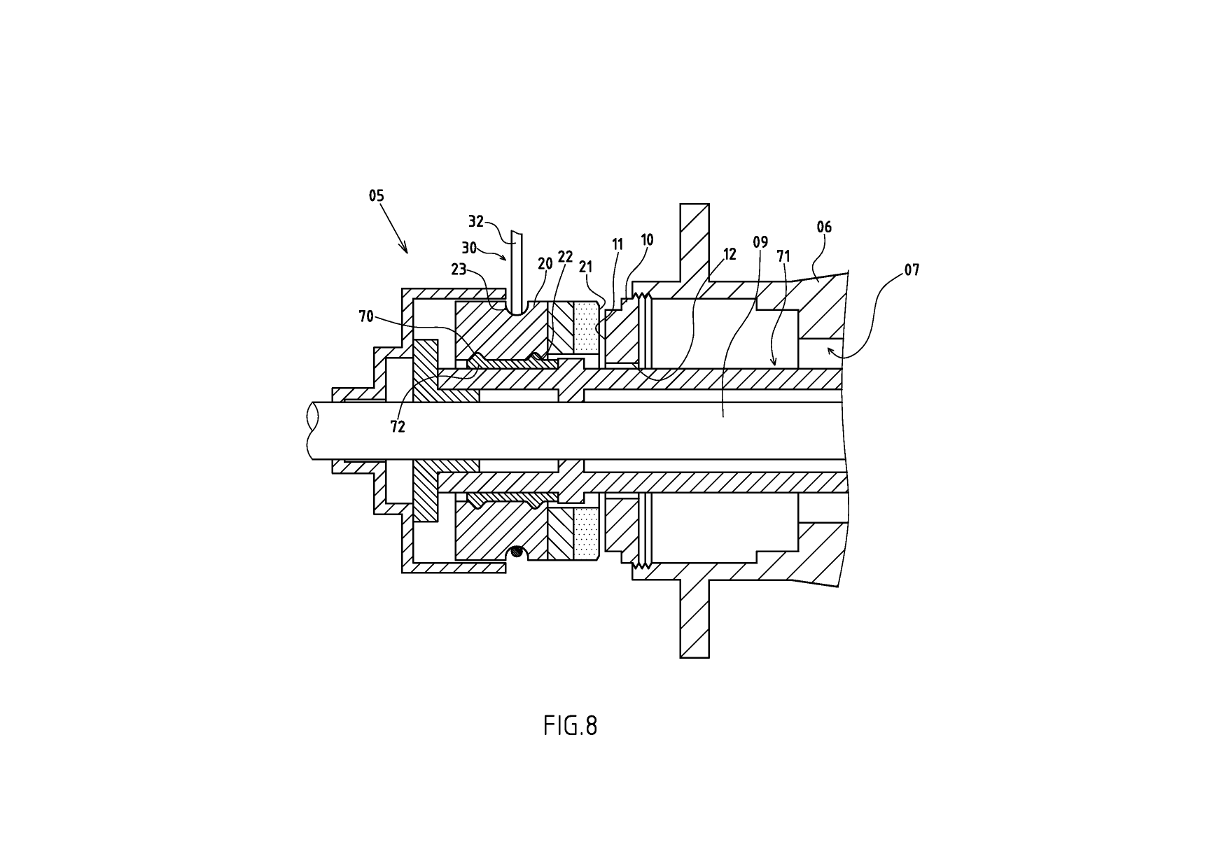

Referring to FIG. 8, the fixed brake disc 10 and axial displacement brake disc 20 are installed externally on the hollow tubular space 07 of the hub 06, of which the braking principle and structure of the fixed brake disc 10 and axial displacement brake disc 20 are the same as those mentioned above.

1. A hub brake of bicycle, set into the hub structure of the bicycle's front or rear wheel for braking purpose; the hub is provided with a hollow tubular space and pivoted via the bearing onto the periphery of the axle of the bicycle's front or rear wheel; the hub brake comprising:
a fixed brake disc, assembled securely at one end of the hub and located onto the exterior of the bearing; the fixed brake disc comprises of a first braking surface with its orientation the same as the axial direction of the axle; the center of the fixed brake disc is provided with a penetrating portion for the axle;
an axial displacement brake disc, assembled at one end of the hub and located onto the exterior of the fixed brake disc correspondingly; the axial displacement brake disc comprises of a second braking surface correspondingly to the first braking surface of the fixed brake disc; a guide sleeving portion at the center of the axial displacement brake disc is assembled at the periphery of the axle, and allowed for axial displacement along the axle; moreover, the axial displacement brake disc is provided with a driven portion, so as to control the braking or disengagement state between the first and second braking surfaces;
a brake member, comprising of a driving end and a driven end, of which the driven end is connected with the driven portion set on the axial displacement brake disc, and the driving end connected with the brake handle preset on the bicycle;
the axial displacement brake disc is driven by the brake member to yield axial displacement, thus realizing hub braking through frictional abutting of the fixed brake disc.

2. The device defined in claim 1, wherein the guide sleeving portion of said axial displacement brake disc is designed with screwed holes, so that a male screwed section is set on the periphery of the axle; with the mating of the screwed guide sleeving portion and male screwed section, the axial displacement brake disc enables axial displacement through rotation, so that the first and second braking surfaces could be engaged frictionally for braking; moreover, the driven portion set on the axial displacement brake disc is designed with a protruding arm, the brake member is designed with a rope body, and the driven end of the brake member is connected at the end of the driven portion.

3. The device defined in claim 1, wherein the guide sleeving portion of said axial displacement brake disc has straight holes and is sleeved on the periphery of the axle; a directional limiting portion is set correspondingly to the guide sleeving portion and the axle, so as to prevent the rotation of the axial displacement brake disc in relation to the axle; moreover, the driven portion is formed by one end surface of the axial displacement brake disc; the driven end of the brake member is also provided with a swinging arm composed of eccentric cam and fulcrum; the swinging arm is located via the fulcrum correspondingly to the outer end surface of the axial displacement brake disc; when the swinging arm is pulled by the brake member to a certain angle, the eccentric cam is driven to push the outer end surface of the axial displacement brake disc, realizing the braking of the first and second braking surfaces through frictional abutting; moreover, the axial displacement brake disc could be reset to the release state via the setting of an elastic member.

4. The device defined in claim 1, wherein the fixed brake disc and axial displacement brake disc are assembled into or externally onto the hub's hollow tubular space.

5. The device defined in claim 1, wherein the fixed brake disc and axial displacement brake disc are made of highly thermostable metals; either the first or the second braking surface is made of highly thermostable, wearproof combinations of ceramic and metals.

6. The device defined in claim 1, wherein the first and second braking surfaces of the axial displacement brake disc are of any flat, curved and rugged planes.

7. The device defined in claim 1, wherein a concave portion is set locally onto either the first or second braking surface of the axial displacement brake disc, so as to remove chips and heat quickly.

8. The device defined in claim 1, wherein an auxiliary heat emission structure such as air vent or cooling fin is set onto the hub correspondingly to the assembly position of the fixed brake disc and axial displacement brake disc.

9. The device defined in claim 1, wherein the assembly position of the fixed brake disc and axial displacement brake disc correspondingly to the hub could be designed into external diameter expansion pattern, so as to increase the configuration area of the fixed brake disc and axial displacement brake disc.

10. The device defined in claim 1, wherein said brake member is a hydraulic braking type.
